(19) United States
(12) Patent Application Publication
(10) Pub. No.: US 2018/0302785 A1
(43) Pub. Date: Oct. 18, 2018

(54) RADIO NODE, NETWORK NODE, METHODS THEREIN, COMPUTER PROGRAMS AND COMPUTER-READABLE MEDIUMS COMPRISING THE COMPUTER PROGRAMS, FOR ESTABLISHING A DIRECT CONTROL LINK

(71) Applicant: Telefonaktiebolaget LM Ericsson (publ), Stockholm (SE)

(72) Inventors: Anna Larmo, Espoo (FI); Osman Nuri Can Yilmaz, Espoo (FI)

(21) Appl. No.: 15/527,069

(22) PCT Filed: Nov. 25, 2014
(86) PCT No.: PCT/SE2014/051404

§ 371 Date: May 16, 2017

(51) Int. Cl. H04W 8/24; H04L 29/06; H04W 76/27; H04W 88/10

(52) U.S. Cl. CPC H04W 8/24; H04L 69/24; H04W 88/04; H04W 88/10; H04W 76/27

(57) ABSTRACT

Method performed by a radio node for establishing a direct control link with a network node. The network node operates in a cellular communications system. The radio node operates as a user equipment in the cellular communications system. The radio node sends an indication to the network node. The indication is one of: a category and a capability. The indication comprises an indication that the radio node is capable of operating in the cellular communications system as a short-range radio gateway. The radio node establishes the direct control link with the network node according to the sent indication.

### TECHNICAL FIELD

The present disclosure relates generally to a radio node and methods therein for establishing a direct control link with a network node. The present disclosure relates generally to the network node and methods therein for establishing the direct control link with the radio node. The present disclosure further relates generally to computer programs and computer-readable storage mediums, having stored thereon the computer programs to carry out these methods.

### BACKGROUND

Communication devices such as terminals are also known as e.g. User Equipments (UEs), wireless devices, mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a Base Station (BS), e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3^{rd} Generation Partnership Project (3GPP) Long Term Evolution (LTE), base stations, which may be referred to as Evolved Nodes B (eNodeBs) or even eNBs, may be directly connected to one or more core networks.

3GPP LTE radio access standard has been written in order to support high bitrates and low latency both for uplink and downlink traffic. All data transmission is in LTE controlled by the radio base station.

In heterogeneous networks, the density of wireless Access Points (APs) is getting closer to the average density of UEs. Therefore, a UE may be under the coverage of at least several cells and multiple radio technologies at a time. Also, most UEs capable of Wi-Fi may act as Wi-Fi APs towards other end user devices like laptops and tablets that for example, are not equipped with Subscriber Identity Module (SIM) cards and for which, network access may not be available, or which are equipped with a SIM card, but the user prefers not to use it. In practice, a UE acting as a Wi-Fi AP with a 3GPP backhaul may be seen as providing a capillary network, providing Internet access to the devices under the coverage of the Wi-Fi AP.

In the existing 3GPP networks, the Access Network Discovery and Selection Function (ANDSF) within the Evolved Packet Core (EPC) of the system architecture evolution (SAE) may assist a UE to discover non-3GPP access networks, e.g., Wi-Fi, that may be used for data communications, in addition to 3GPP access networks, such as High-Speed Packet Access (HSPA) or LTE.

To allow for a wide range of UE implementations for a UE to access a network, different UE capabilities may be specified. The UE capabilities may be divided into a number of parameters, which may be sent from the UE at the establishment of a connection, and if/when the UE capabilities are changed during an ongoing connection. The UE capabilities, e.g., supported bit rates, antenna configurations, bandwidths, supported access types, etc . . . , may then be used by the network to select a configuration that is supported by the UE.

Generally, UE capabilities may be classified into mainly two sets of capability categories depending on which layer of the protocol hierarchy the given capability information may be related to Access Stratum (AS) capabilities or Non Access Stratum (NAS) capabilities. Examples of existing UE capabilities are specified in 3GPP TS 36.331, version 12.3.0, for as comprised in a ueCapabilityRAT-Container.

AS capabilities are the access technology dependent parts of the capability information such as terminal power class, supported frequency band etc. . . . . The AS capabilities may be needed by the serving radio network node, e.g., an eNB. Any reference in the description of capability or category to eNB is understood to apply to any equivalent radio network node.

NAS capabilities are a set of capability information that holds the non-access specific parts of the UE capability such as supported security algorithms. The NAS capabilities may be used by the EPC.

Information on the AS part of the UE capabilities may need to be present in the eNB in the active state of the UE. Moreover, when a handover is made from a first eNB to a second eNB, the UE capability information may need to be moved from the first eNB to the second eNB. However, for a UE in the idle state, there may be no need to maintain any UE information, including the UE capabilities, in the eNBs, but only in the EPC. Thus, when a UE transits to active state again, the information of the UE, including the UE capabilities, may be recreated in the eNB.

Furthermore, there exist several ways to convey information about UE capabilities. There is the UE class or category information, which denotes some expectations on the UE capabilities. Examples of the existing UE classes or categories are specified in 3GPP TS 36.306, version 12.2.0. There may also be separate UE capability signaling over the Radio Resource Control (RRC) protocol. Furthermore, the UEs may indicate whether or not they support certain standardized features through feasibility signaling.

Existing approaches for managing the mobility of a UE from one 3GPP network to a Wi-Fi network involve the ANDSF procedure. 3GPP has spent several years standardizing the ANDSF. In Release 12, 3GPP has worked on the alignment of ANDSF with the HotSpot 2.0, a Wi-Fi Alliance specification, capabilities.

Another existing approach relates to the Extensible Authentication Protocol (EAP)-Authentication and Key Agreement AKA/SIM based authentication and S2a-based Mobility over General packet radio services Tunneling Protocol (GTP) (SaMOG) Trusted Access to the 3GPP core via Wi-Fi. This procedure may allow end users to seamlessly roam between cellular and Wi-Fi access networks, that is to roam without a communication interruption.

Other methods for Device-to-device systems for 3GPP may also be applicable approaches.

However, all in all, the existing approaches to establish a control link between a network node operating in a cellular communications system and a radio node utilizing a non-cellular communications technology may require additional nodes to be involved in the signaling between the non-cellular radio technology network and the cellular network. Such network nodes may be for example, a Wi-Fi controlling node(s) and/or an intermediate node(s) that functions between the Wi-Fi controlling node and an LTE core network node. Moreover, the control links established under the existing approaches provide limited benefits.

### SUMMARY

It is an object of embodiments herein to improve the performance in a wireless communications network by providing a simplified method for establishing a communication between a network node operating in a cellular communications system and a radio node operating in a non-cellular communications system.

According to a first aspect of embodiments herein, the object is achieved by a method performed by a radio node for establishing a direct control link with a network node. The network node operates in a cellular communications system. The radio node operates as a user equipment in the cellular communications system. The radio node sends an indication to the network node. The indication is one of: a category and a capability. The indication comprises an indication that the radio node is capable of operating in the cellular communications system as a short-range radio gateway. The radio node establishes the direct control link with the network node according to the sent indication.

According to a second aspect of embodiments herein, the object is achieved by a method performed by the network node for establishing the direct control link with the radio node. The network node operates in the cellular communications system. The radio node operates as a user equipment in the cellular communications system. The network node obtains the indication from the radio node. The indication is one of: a category and a capability. The indication comprises the indication that the radio node is capable of operating in the cellular communications system as a short-range radio gateway. The network node establishes the direct control link with the radio node according to the obtained indication.

According to a third aspect of embodiments herein, the object is achieved by the radio node configured to establish the direct control link with the network node. The network node is configured to operate in the cellular communications system. The radio node is configured to operate as a user equipment in the cellular communications system. The radio node is further configured to send the indication to the network node. The indication is one of: a category and a capability. The indication comprises the indication that the radio node is capable of operating in the cellular communications system as a short-range radio gateway. The radio node establishes the direct control link with the network node according to the indication configured to be sent.

According to a fourth aspect of embodiments herein, the object is achieved by the network node configured to establish the direct control link with the radio node. The network node is configured to operate in the cellular communications system. The radio node is configured to operate as a user equipment in the cellular communications system. The network node is further configured to obtain the indication from the radio node. The indication is one of: a category and a capability. The indication comprises the indication that the radio node is capable of operating in the cellular communications system as a short-range radio gateway. The network node is further configured to establish the direct control link with the radio node according to the obtained indication.

According to a fifth aspect of embodiments herein, the object is achieved by a computer program, comprising instructions which, when executed on at least one processor, cause the at least one processor to carry out the method performed by the radio node.

According to a sixth aspect of embodiments herein, the object is achieved by a computer-readable storage medium, having stored thereon the computer program, comprising instructions which, when executed on at least one processor, cause the at least one processor to carry out the method performed by the radio node.

According to a seventh aspect of embodiments herein, the object is achieved by a computer program, comprising instructions which, when executed on at least one processor, cause the at least one processor to carry out the method performed by the network node.

According to an eighth aspect of embodiments herein, the object is achieved by a computer-readable storage medium, having stored thereon the computer program, comprising instructions which, when executed on at least one processor, cause the at least one processor to carry out the method performed by the network node.

By the network node obtaining from the radio node the indication that the radio node is capable of operating in the cellular communications system as a short-range radio gateway, the short-range radio gateway operating as a UE, the network node is able to establish a direct control link with the radio node. The network node may this way avoid signalling with the radio node operating in the cellular communications system as a short-range radio gateway through multiple network nodes. Thus, thanks the obtained indication, the overall latency of the cellular communications system is reduced, the capacity is increased, and the user satisfaction is improved, with respect to existing solutions. Moreover, the network node may gain direct access control to the radio node to carry out functions, e.g., offloading of users, that may allow it to improve the functioning of the cellular communications system.

Further advantages of some embodiments disclosed herein are discussed below.

### BRIEF DESCRIPTION OF THE DRAWINGS

Examples of embodiments herein are described in more detail with reference to the accompanying drawings, in which:

FIG. 1 is a schematic diagram illustrating embodiments in a cellular communications system, according to some embodiments.

FIG. 2 is a schematic diagram illustrating a cellular communications system, according to some embodiments.

FIG. 3 is a schematic diagram illustrating embodiments of a method in a radio node, according to some embodiments.

FIG. 4 is a schematic diagram illustrating embodiments of a method in a radio node, according to some embodiments.

FIG. 5 is a schematic diagram illustrating embodiments of a method in a radio node, according to some embodiments.

FIG. 6 is a schematic diagram illustrating embodiments of a method in a radio node, according to some embodiments.

FIG. 7 is a schematic diagram illustrating embodiments of a method in a network node, according to some embodiments.

FIG. 8 is a schematic diagram illustrating embodiments of a method in a cellular communications system, according to some embodiments.

FIG. 9 is a schematic diagram illustrating embodiments of a method in a cellular communications system, according to some embodiments.

FIG. 10 is a schematic diagram illustrating embodiments of a method in a cellular communications system, according to some embodiments.

FIG. 11 is a block diagram of a radio node that is configured according to some embodiments.

FIG. 12 is a block diagram of a network node that is configured according to some embodiments.

### DETAILED DESCRIPTION

Embodiments herein address the problems of the existing approaches discussed earlier to enable efficient control of a cellular network over a network using a short-range/non-cellular radio technology.

Particular embodiments herein relate to enabling efficient LTE network control over Wi-Fi APs, for example, for functions such as offloading, charging, that is, payment for air interface use, configuration, optimization and recovery. The approach described herein concerns defining for a short-range radio gateway, such as a Wi-Fi APs or a node utilizing another non-cellular radio technology, a novel UE category, also referred to as class, and/or a novel capability, as well as associated signaling. The novel UE class and/or capability may provide direct access from a network using a cellular radio technology to the short-range radio gateway. For example, in particular embodiments, an eNB may establish direct access over an LTE air interface to the short-range radio gateway. In the following discussion, for illustration purposes, Wi-Fi may be used as an example for short-range radio technology. However, any description provided for Wi-Fi is understood to apply to any other short-range radio technology.

Embodiments will now be described more fully hereinafter with reference to the accompanying drawings, in which examples of the claimed subject matter are shown. The claimed subject matter may, however, be embodied in many different forms and should not be construed as limited to the embodiments set forth herein. Rather, these embodiments are provided so that this disclosure will be thorough and complete, and will fully convey the scope of the claimed subject matter to those skilled in the art. It should also be noted that these embodiments are not mutually exclusive. Components from one embodiment may be tacitly assumed to be present/used in another embodiment.

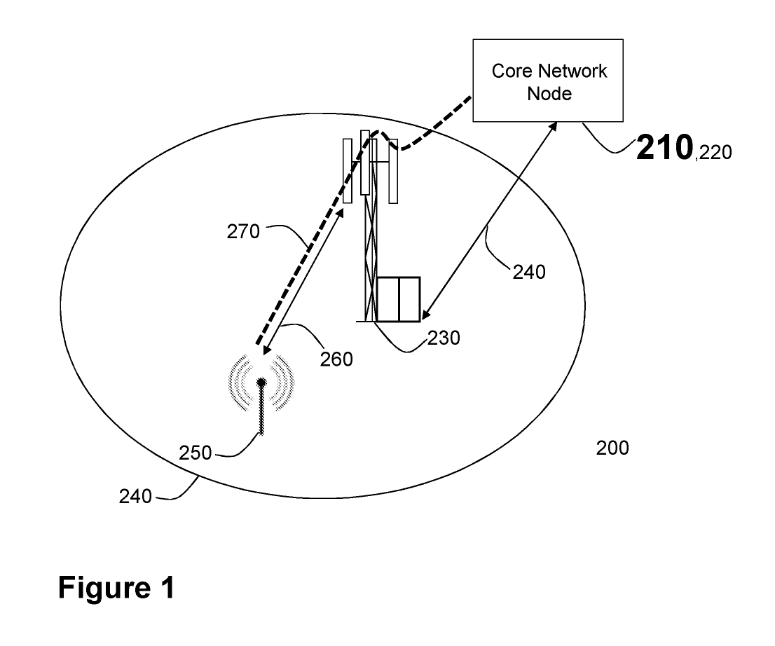

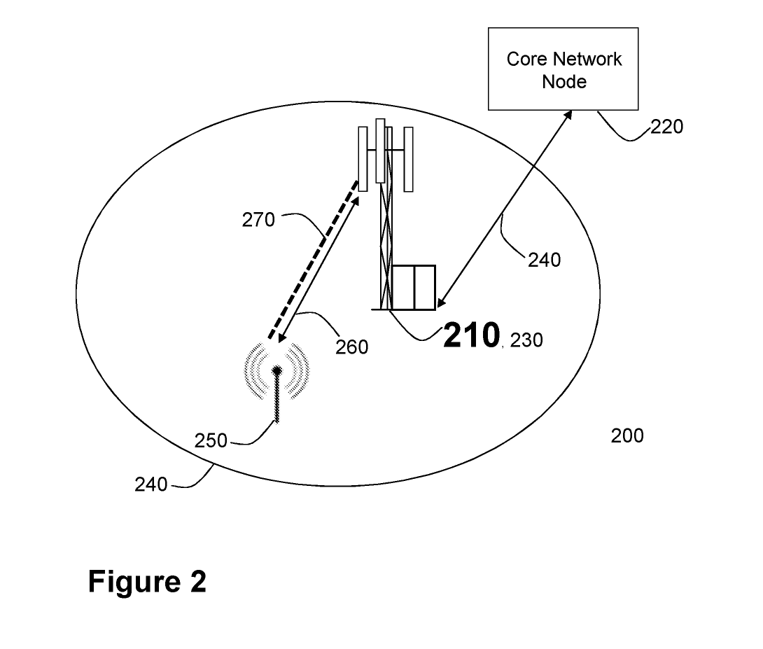

FIGS. 1 and 2 depict a cellular communications system 200 in which embodiments herein may be implemented. The cellular communications system 200 may for example be a network such as a Long-Term Evolution (LTE), e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi network, Worldwide Interoperability for Microwave Access (WiMax), 5G system or any cellular network or system.

The cellular communications system 200 comprises a network node 210. In some embodiments, as shown in FIG. 1, the network node 210 may be a core network node 220. The core network node 220 may be a MME or any other core network element 220 such as a new and dedicated gateway or MME for the Short-Range Radio (SRR)/capillary network management.

In some embodiments, as shown in FIG. 2, the network node 210 may be a radio network node 230 in the cellular communications system 200. The radio network node 230 may be a base station such as e.g. an eNB, eNodeB, or a Home Node B, a Home eNode B, femto Base Station, BS, pico BS or any other network unit capable to serve a wireless device or a machine type communication device in the cellular communications system 200. Thus, in some embodiments, the radio network node 230 may also be referred to herein as the eNB 230. In some particular embodiments, the radio network node 230 may be a stationary relay node or a mobile relay node. The cellular communications system 200 covers a geographical area which is divided into cell areas, wherein each cell area is served by a radio network node, although, one radio network node may serve one or several cells. In the example depicted in FIGS. 1 and 2, the radio network node 230 serves a cell 240. The radio network node 230 may be e.g. macro eNodeB, home eNodeB or pico base station, based on transmission power and thereby also cell size. Typically, the cellular communications system 200 may comprise more cells similar to the cell 240, served by their respective radio network nodes. This is not depicted in FIGS. 1 and 2 for the sake of simplicity. The radio network node 230 may support one or several cellular communication technologies, and its name may depend on the technology and terminology used. The radio network node 230 may communicate with the core network node 220 through a link 240.

The cellular communications system 200 comprises a radio node 250. The radio node 250 is a short-range radio gateway 250, that is, a node utilizing non-cellular radio technology such as a W-Fi AP 250. The radio node 250 may be self-standing, or it may also be, in some embodiments, comprised in a UE. The radio node 250 may be a multi-carrier/multi-radio node, and it may support more than one technology, e.g., IEEE 802.11ah, BLE etc. . . . . A number of radio nodes are located in the cellular communications system 200. In the example scenario of FIGS. 1 and 2, only the radio node 250 is shown. The radio node 250 may communicate with the radio network node 230 over a radio link 260.

The radio node 250 may also communicate with the network node 210 over a direct control link 270, according to embodiments herein. By direct control link it is meant a link that provides direct control access to the radio node 250. The direct control link 270 may be utilized in order to, for example: seamlessly offload the wireless devices capable of operating under both cellular and SRR systems; to transparently manage the access of wireless devices that may not be capable of the cellular connectivity; to directly negotiate pricing, load balancing, the use of the cellular link, i.e., the direct control link 270, as a wireless backhaul, spectrum sharing. In some embodiments, such as those illustrated in FIG. 2, where the network node 210 is a radio network node 230, the direct control link 270 will be understood to not involve any intermediary nodes, as depicted in FIG. 2 with a dashed bold line. In the embodiments such as those illustrated in FIG. 1, where the network node 210 is the core network node 220, the direct control link 270 will be understood to go through the network node 210 in the radio interface, as depicted in FIG. 1 with a dashed bold line. The establishment of this direct control link 270 will be explained later.

The radio node 250 operates in the cellular communications system 200 as a UE 280, which is not depicted in FIGS. 1 and 2. That is, radio node 250 operates in the cellular communications system 200 as a wireless communication device, also known as e.g. mobile terminal, wireless terminal and/or mobile station. The UE 250 is wireless, i.e., it is enabled to communicate wirelessly in the cellular communications system 200, sometimes also referred to as a cellular radio system or cellular network. The communication may be performed e.g., between two UEs, between the UE 280 and a regular telephone and/or between the UE 280 and a server. The communication of the UE 280 may be performed e.g., via a RAN and possibly one or more core networks, comprised within the cellular communications system 200.

The UE 280 may further be referred to as a mobile telephone, cellular telephone, or laptop with wireless capability, just to mention some further examples. The UE 280 in the present context may be, for example, portable, pocket-storable, hand-held, computer-comprised, or vehicle-mounted mobile devices, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) devices, devices equipped with a wireless interface, such as a printer or a file storage device, modems, or any other radio network unit capable of communicating over a radio link in a cellular communications system 200.

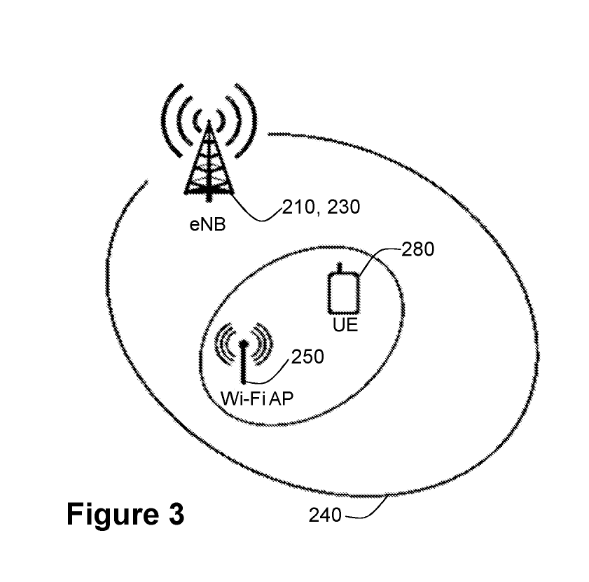

Embodiments herein provide for a method that may equip the radio node 250, which employs a non-cellular, short-range radio technology, with cellular technology, so that the radio node 250 may be seen from the cellular communications system 200 as the UE 280. Particular embodiments herein may particularly concern control of the Wi-Fi AP 250 through 3GPP radio. For example, the W-Fi AP 250 may be equipped with 3GPP technology so that the Wi-Fi AP 250 may be seen from the 3GPP network 200 as the UE 280. This is represented in FIG. 3, which illustrates that the Wi-Fi AP 250 in the coverage area, e.g., the cell 240, of the eNB 230 may be seen as the UE 280 in the cellular communications system 200, which in this particular embodiment is an LTE network.

In embodiments herein, the Wi-Fi AP 250 may now also be acting as a 3GPP UE. A novel UE class, capability, and/or associated signaling may be defined to denote that the particular UE is e.g., the Wi-Fi AP 250. The Wi-Fi AP 250 may be categorized as a new UE class in order to avoid unnecessary signaling traffic between the Wi-Fi AP 250 and the network node 210. For instance, RRC connection setup and NAS attachment and registration may be simplified for the W-Fi AP 250 this way. After identifying a UE as the Wi-Fi AP 250, the direct control link 270 between the radio network node 230 and the W-Fi AP 250 in its coverage area may be opened. The radio network node 230 may be a controlling element or a transparent network element between the Wi-Fi AP 250 and the core network node 220. Embodiments herein may be also used to indicate capability and provide optimized signaling for other short-range/non-cellular radio technologies such as Bluetooth Low Energy (BLE).

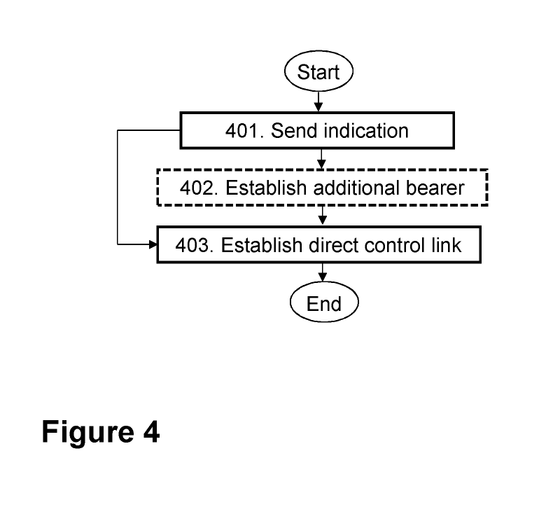

Embodiments of a method performed by the radio node 250 for the establishing a direct control link 270 with the network node 210, will now be described with reference to the flowchart depicted depicted in FIG. 4. As stated earlier, the network node 210 operates in the cellular communications system 200. The radio node 250 operates as the UE 280 in the cellular communications system 200.

In some embodiments, the radio node 250 may be the Wi-Fi Access Point 250.

The cellular communications system 200 may be a 3GPP network.

In some embodiments, the network node 210 may be the core network node 220, as shown in FIG. 1.

In some embodiments, the network node 210 may be the radio network node 230, e.g., the eNB 230, as shown in FIG. 2.

The method may comprise the following actions, which actions may as well be carried out in another suitable order than that described below.

Action 401

In order to equip the radio node 250, employs a non-cellular, short-range radio technology, with cellular technology so that the radio node 250 may be seen by the network node 210 as the UE 280, the radio node 250 may need to signal to the network node 210 its functionality, as if it were the UE 280 operating in the cellular communications system 200.

Thus, in this action, the radio node 250 sends an indication to the network node 210. The indication is one of: a category and a capability. The indication comprises an indication that the radio node 250 is capable of operating in the cellular communications system 200 as a short-range radio gateway 250, e.g., the Wi-Fi Access Point 250. Based on this indication, the network node 210 may not treat 250 just as a regular UE or a UE that has a non-cellular radio capability, but as a short-range radio gateway 250.

Category information may be used to allow the radio network node 230 to communicate effectively with all the radio nodes, such as UEs, connected to it. In some embodiments, the category may be a UE category. The UE-Category may define a combined UL and DL capability as, for example, specified in 3GPP TS36.306, version 12.2.0.

As for the capability, in most communication protocols, parties participating in a communication, exchange information about their capability, so that the each party does not request any capability which is not supported by its counterpart. In mobile communication, e.g, LTE, WCDMA, a network may inform on its capability via various System Information Block (SIB) messages, and a radio node, e.g., a UE, may inform about its capability via various RRC or NAS messages. In WCDMA, a UE may inform on its capability as a part of an RRC Connection Complete message, and in LTE, a separate message may be defined solely for this kind of capability information report. Whenever a network, e.g., the radio network node 230, wants to know a UE capability, in most cases, this may be during registration, the network may send a ‘UE Capability Enquiry’ message specifying which information it wants to get. There may be five different types of capability items. The network may specify any one or multiple items in a UE Capability Enquiry message. Then, a UE has to report all the capability information requested by the Network. In some embodiments, the capability may thus be UE capability.

A new UE category, or class, and an associated capability signaling may be defined e.g., for the RRC protocol in a 3GPP radio system, such as LTE or WCDMA, for the optimized signaling and information exchange. The capability signaling may be similar to the existing UE capability signaling but introduced with a new UE class.

Defining a new UE class or category may be beneficial for the radio node 250, as the radio connectivity between the radio node 250 and cellular communications system 200 may be optimized, e.g., by defining new values and capabilities for the radio node 250—network node 210 communications. For example, in some embodiments, the indication may define new Wi-Fi AP-LTE network communications, such as: a) a maximum number of DL-Synchronization CHannel (SCH) transport block bits received in a Transmission Time Interval (TTI), b) a maximum number of bits of a DL-SCH block received in a TTI, c) a total number of soft channel bits, d) a maximum number of supported layers for spatial multiplexing in DL, e) a maximum number of bits of an UL-SCH transport block received in a TTI, f) a support for a new modulation in UL/DL.

The category sent in this action may be a new UE category with respect to those specified in 3GPP TS 36.306, version 12.2.0. Thus, in some embodiments the indication may be a category different from any one of: Category 0, Category 1, Category 2, Category 3, Category 4, Category 5, Category 6, Category 7, Category 8, Category 9, and Category 10.

The capability sent may be a new UE capability with respect to the UE capabilities specified for the ueCapabilityRAT-Container in 3GPP TS 36.331, version 12.3.0. Thus, in some embodiments the indication may be a new field in the ueCapabilityRAT-Container.

In the embodiments wherein the indication is a capability, the capability may be at least one of: a static capability, and a dynamic capability.

A dynamic capability is called this way because it may change in time, and it may need to be reported more often, whereas a static capability may only be reported in the beginning of link establishment. That is, a dynamic capability may be reported more often than a static capability.

The same capability may be static in some embodiments and dynamic in others. For example, a short range radio carrier frequency such as a Wi-Fi carrier frequency or frequencies, used and/or supported by the radio node 250, and short range radio bands used and/or supported by the radio node 250, e.g., the Wi-Fi AP 250, may be each considered a static or dynamic capability. These capabilities may be used, for example, by the radio network node 230 for recommending a carrier frequency from the cellular communications system 200 to minimize interference with other possible radio nodes in a surrounding area.

Another capability that may be considered static or dynamic is a notion of whether the radio node 250 accepts offloaded users from the cellular communications system 200. Offloaded users may be those users that the cellular communication system 200 chooses not to serve at a particular time, and thus transfers them over to the radio node 250. Offloaded users may have a certain subscription type, UE capability/category, UE type, supported radio technology, used application etc. . . . . The radio node 250 may, for example, indicate that it is a paid short-range radio gateway in its capability signaling, then the network node 210 may request information on pricing and payment methods via the direct control link 270. After receiving the further information, with or without the consent/approval of user, a short-range radio gateway operation may start. This capability may include, for example, a possible price for accepting offloaded users from the cellular communications system 200. Another example of this capability may be payment methods the radio node 250 may accept for such an offloading service: e.g., credit card, charge through a phone bill from the user, etc. . . .

Yet another capability that may be considered static or dynamic is an indication of a capability of the radio node 250 to use a 3GPP link as a wireless backhaul. This indication may be, for example, a request to use the 3GPP link as a wireless backhaul. In other embodiments, depending on the subscription, the indication of the capability to use a 3GPP link as the wireless backhaul may not be a request but a preference.

An example of dynamic capability is: a current load of the Wi-Fi whenever a predefined threshold is exceeded for a required time. Through this capability, the radio node 250 may provide to the network node 210 its changing offloading capability, with regards to the notion of whether the radio node 250 accepts offloaded users from the cellular communications system 200 explained above. If there is enough capacity left, that is, if the load is low in the radio node 250, more devices may be offloaded to the radio node 250. A predefined threshold, e.g., set by the operator or by hardware or radio resources, may determine whether the current load is low or high, depending on whether the load is under, equal, or above the predefined threshold. A time may be defined as well to exceed the predefined threshold before an offloading capability may be considered to have changed, so that short-lived changes in load may not trigger that more users are accepted or rejected for offloading from the cellular communications system 200. This defined time is referred to herein as the required time.

An example of a static capability is a used and/or supported security mechanism by the radio node 250. This capability may include or be followed by, for example, a security exchange to enable devices in the cellular communications system 200 to access the radio node 250 in case of offloading.

According to the foregoing, the capability that may be sent by the radio node 250 in this action may comprise at least one of: used and/or supported short-range radio technologies, used and/or supported short range radio carrier frequency, used and/or supported short range radio bands, used and/or supported security mechanism, an indication of whether offloaded users from the cellular communications system (200) are accepted, a capability to use a 3GPP link as a wireless backhaul, and a current load of the radio node (250) when a threshold is exceeded for a required time. Used and/or supported refers here to the radio node 250.

As many smartphones already today have the ability to share their connection through being a Wi-Fi AP, i.e., being in tethering mode, whenever the end user so wants, new RRC or NAS signaling messages may be defined herein to send the indication to the network node 210, which may be transmitted whenever the radio node 250 is turned on, or a tethering mode in the radio node 250 is enabled. The information exchange may be initiated by the radio node 250, or the network node 210 may inquire this information. If redundant radio node 250-initiated signaling is not desired, the radio node 250 may, for example, send the indication in the RRCConnectionSetupComplete message, and then wait for the network node 210 to inquire more details. Similarly, if the W-Fi AP is switched off in the radio node 250, or there is a malfunction in a W-Fi AP with the radio node 250 when the cellular communications system 200 uses 3GPP technology, a shutdown or malfunction signal may be sent to the network node 210 over the control interface. An example messaging with new RRC/NAS messages is shown later.

Thus, in some embodiments, the sending of the indication is performed by sending an RRC message. In some of these embodiments, the network node 210 may be the eNB 230.

In other embodiments, the signaling may be implemented on a NAS level, and the network node 210 may be the core network node 220, perhaps an MME there, instead of the radio network node 230. However, the radio interface may still be used to convey the control information.

Thus, in some embodiments, the sending of the indication is performed by sending a NAS message. In some of these embodiments, the network node 210 may be the core network node 220.

In some embodiments, the indication may further indicate whether a tethering mode in the radio node 250 is enabled. Thus, the new indicator bit may be used for the existing phones to denote when the tethering mode is on and again to denote when it is off.

Action 402

In some embodiments, as a preparation for the radio node 250 to establish the direct control link with the network node 210, the radio node 250, in this action may establish an additional user plane radio access bearer between the radio node 250 and the network node 210 to an already established user plane radio access bearer between the radio node 250 and the network node 210. This may be implemented for example, after sending the indication to the network node 210. For instance, the radio node 250 may update its capability when it switches on a short-range radio gateway feature. Upon receiving short-range radio gateway capability signaling, the network node 210 may establish an additional user plane radio access bearer with the radio node 250. The additional user plane radio access bearer between the radio node 250 and the network node 210 may be a dedicated user plane radio bearer for short-range radio gateway 250, which radio bearer may have different priorities and Quality of Service (QoS) requirements than the existing radio bearer/s.

In some embodiments the additional user plane radio access bearer may comprise only the RAN, in which case the bearer is a radio access bearer terminating in the radio network node 220, e.g., the eNB 230. In other embodiments wherein the core network node 220 is behind the RAN, the bearer may be a System Architecture Evolution (SAE) bearer as well.

This action is optional.

Action 403

In this action, the radio node 250 establishes the direct control link 270 with the network node 210 according to the sent indication. Through this action, the radio node 250 may communicate with the network node 210 as the UE 280 having short-range radio gateway functionality. The establishment of the direct control link 270 with the network node 210 according to the sent indication may allow the network node 210 to utilize the information comprised in the indication described above for different purposes such as, but not limited to, simplification of the signalling involved in the communication between the network node 210 and the radio node 250, minimizing interference in the short-range radio technology, possible offloading of UEs to the short-range radio gateway 250, etc. . . .

The direct control link 270 may be used to communicate with the radio node 250, for example, to agree handovers to and from the radio node 250. Further uses of the direct control link 270 may include, but are not limited to, configuring the radio node 250.

By establishing the direct control link 270 with the network node 210 according to the sent indication, the radio connectivity between the radio node 250 and cellular communications system 200 may be optimized by the network node 210, as explained above.

The signalling involved in the communication between the network node 210 and the radio node 250 may be simplified. Thereby, capacity of the cellular communications system 200 may be saved. Thus, for example, once the capability signaling is in place, the eNB 230 may have a direct communication link to the Wi-Fi AP 250 within its coverage.

In another embodiment, the direct control link 270 may act as a wireless backhaul when wired backhaul performance degrades or is not available or sufficient.

With regards to minimizing interference in the short-range radio technology, by establishing the direct control link 270 with the network node 210 according to the sent indication, the network node 210 may then instruct or recommend to the radio node 250 to select a carrier which is not heavily or widely used in the neighboring area.

With regards to offloading of UEs to the short-range radio gateway 250, by establishing the direct control link 270 with the network node 210 according to the sent indication, the network node 210 may then offload users to the radio node 250, which is not under operator control by default. Moreover, the offloading may be seamless, fast and optimal, with reduced signaling.

In the embodiments wherein the radio node 250 is a UE acting as a Wi-Fi APs, this particular type of radio node 250 may be specified with their own capability class. If the communication over the direct control link 270 may be limited to LTE eNB controlled control information only, such radio nodes 250 may even act without a SIM card, thus enabling the APs to connect to any LTE network operators to which there is coverage.

The establishing of the direct control link 270 with the network node 210, may involve an exchange of a number of messages between the radio node 250 and the network node 210. For example, the establishing of the direct control link 270 may be implemented by exchanging a number of RRC messages. Static capability information may be included in a RRC connection complete message.

The direct control link 270, in some embodiments may be a 3GPP direct control link 270.

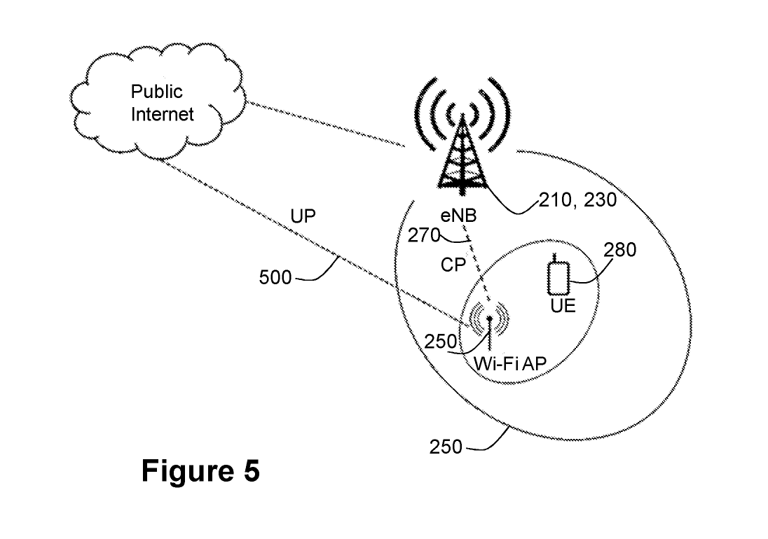

A use case of embodiments herein, relates to embodiments wherein the radio node 250 is an AP with backhaul over cable, DSL, fiber, etc . . . , the radio node 250 may benefit from a control interface over the cellular, e.g., 3GPP, air interface as well, e.g., for keeping track of charges incurred. In this case, the direct control link 270 may only carry Control Plane (CP) data. User Plane (UP) data may be routed through the backhaul. This is depicted in FIG. 5, which illustrates that the radio node 250, in this example a Wi-Fi AP 250, may be seen as the UE 280 from the cellular communications system 200. The cellular communications system 200 may be in this case, e.g. an LTE network 200. A CP connection with the direct control link 270 over the LTE air interface may be formed even if the UP data goes the legacy route, that is through a backhaul 500.

At the same time, the direct control link 270 over, in this particular example, 3GPP, may serve as a backup backhaul in case the primary backhaul 500 is not working.

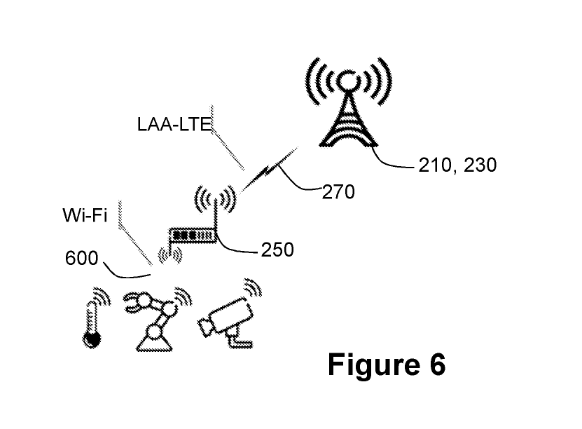

Another use case for embodiments herein wherein the network node 210 is the radio network node 230, may be a situation where the radio network node 230 may use License Assisted Access (LAA) for LTE over an Industrial, Scientific and Medical radio band (ISM). This band may just be the same frequency band where Wi-Fi is already used today. The radio node 250 may at the same time be tethering, i.e., acting as a Wi-Fi AP 250 on the DL to another device. In this case, it may be beneficial to avoid using the same ISM band on the two radios, that is, LAA and Wi-Fi to tether. This use case is depicted in FIG. 6, which illustrates that the use case where the radio network node 230 is using LAA-LTE to communicate with the Wi-Fi AP 250, operating as UE, that is at the same time tethering Wi-Fi to other devices, such as a thermometer, a machine, and a camera. The LAA-LTE over a first ISM connection, depicted at the top of FIG. 6, is carrying the direct control link 270, while the Wi-Fi tethered over a second ISM connection 500, depicted at the bottom of FIG. 6, should be performed over another frequency.

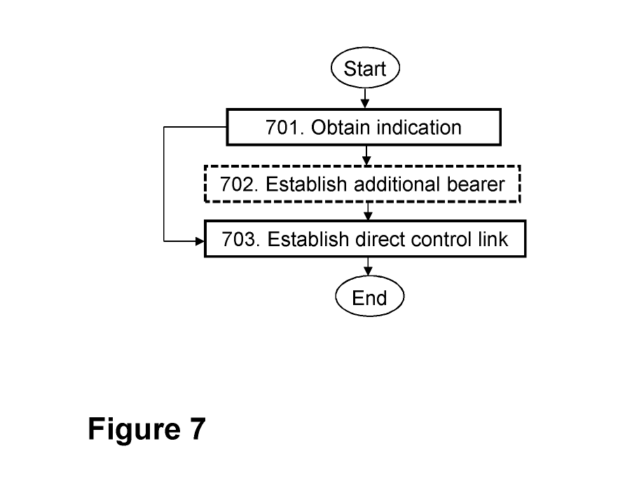

Embodiments of a method performed by the network node 210 for establishing the direct control link 270 with the radio node 250, will now be described with reference to the flowchart depicted depicted in FIG. 7. As stated earlier, the network node 210 operates in the cellular communications system 200. The radio node 250 operates as a user equipment 280 in the cellular communications system 200.

The detailed description of some of the following corresponds to the same references provided above, in relation to the actions described for the radio node 250, and will thus not be repeated here.

For example, in some embodiments, the radio node is the Wi-Fi Access Point 250, and the cellular communications system 200 is a 3GPP network.

The method may comprise the following actions, which actions may as well be carried out in another suitable order than that described below.

Action 701

In order to equip the radio node 250, employs a non-cellular, short-range radio technology, with cellular technology so that the radio node 250 may be seen by the network node 210 as the UE 280, in this action, the network node 210 obtains the indication from the radio node 250. The indication is one of: a category and a capability. The indication comprises the indication that the radio node 250 is capable of operating in the cellular communications system 200 as the short-range radio gateway 250.

In some embodiments, the capability comprises at least one of: used and/or supported short-range radio technologies, used and/or supported short range radio carrier frequency, used and/or supported short range radio bands, used and/or supported security mechanism, an indication of whether offloaded users from the cellular communications system (200) are accepted, a capability to use a 3GPP link as a wireless backhaul, and a current load of the radio node (250) when a threshold is exceeded for a required time.

As stated earlier, the capability is at least one of: a static capability, and a dynamic capability.

The indication may be one of: the new field in the ueCapabilityRAT-Container, and the category different from any one of: Category 0, Category 1, Category 2, Category 3, Category 4, Category 5, Category 6, Category 7, Category 8, Category 9, and Category 10.

In some embodiments, the obtaining the indication is performed by receiving a Radio Resource Control message. In some of these embodiments, the network node 210 is the eNB 230.

In some embodiments, the obtaining the indication is performed by receiving a Non Access Stratum message. In some of these embodiments, the network node 210 is the core network node 220.

In some particular embodiments, the indication further indicates whether a tethering mode is enabled.

Action 702

In some embodiments, as a preparation for the network node 210 to establish the direct control link with the radio node 250, the network node 210, in this action may establish the additional user plane radio access bearer between the radio node 250 and the network node 210 to the already established user plane radio access bearer, between the radio node 250 and the network node 210, as described before for action 402.

This action is optional.

Action 703

In order to simplify the signalling involved in communicating with the radio node 250, and thereby, saving capacity of the cellular communications system 200, in this action, the network node 210 establishes the direct control link 270 with the radio node 250 according to the obtained indication, similarly to what was described earlier for action 403.

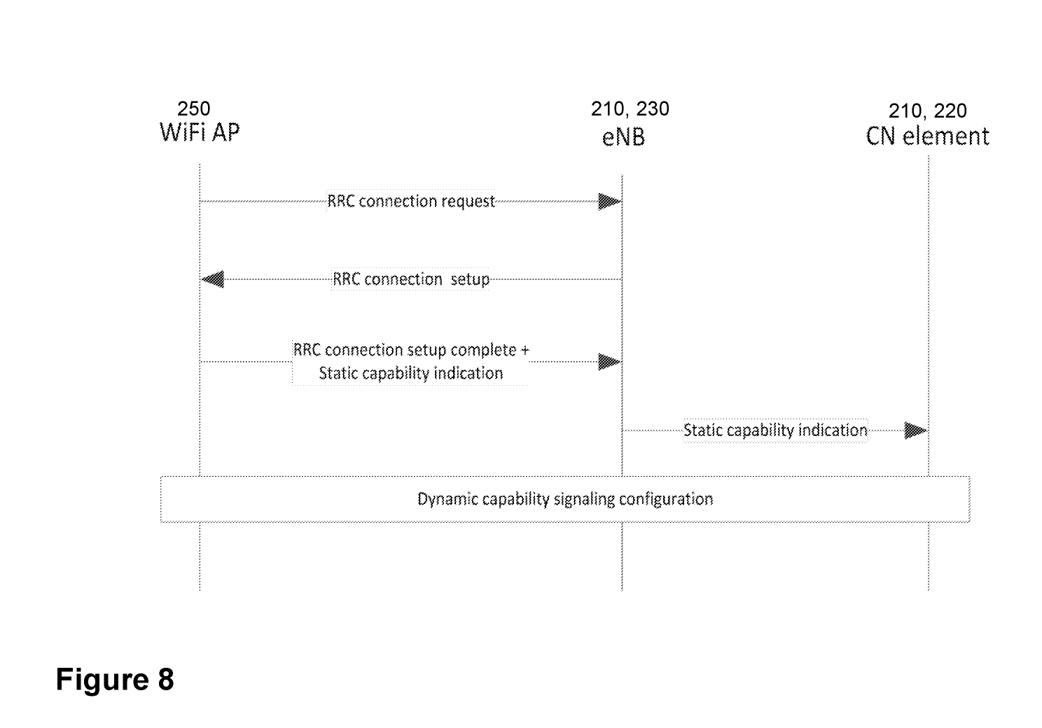

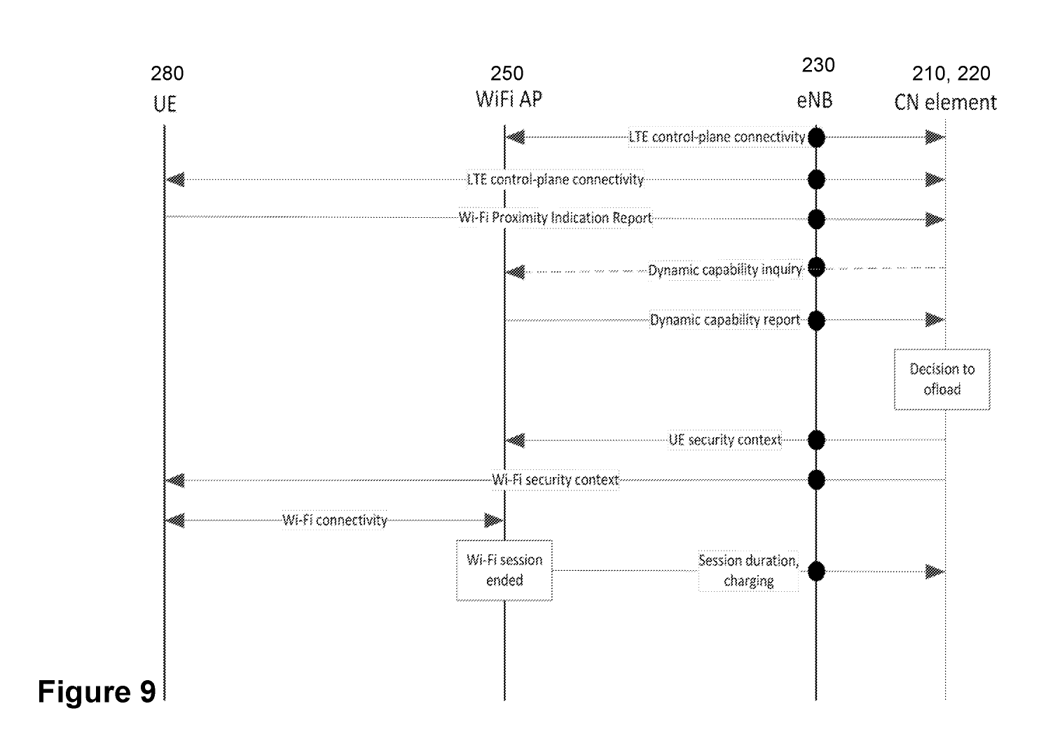

An example messaging with the new UE-WiFi-capability RRC/NAS messages mentioned earlier is shown in FIGS. 8 and 9. FIG. 8 shows an example of static capability signaling and the configuration of dynamic capability signaling according to embodiments herein, wherein the radio node 250 is the Wi-Fi AP 250, and the radio network node 230 is the eNB 230. The indication comprises static capabilities and dynamic capabilities. FIG. 8 shows the two possible scenarios, where the radio node 230 is the network node 210, and where the core network node 220, depicted as CN element 220, is the network node 210. In the example of this Figure, the Wi-Fi AP 250 sends an RRC connection request to the eNB 230 with a UE identifier, for example, a Wi-Fi ID. The eNB 230 responds by setting up the connection. The Wi-Fi AP 250 then first reports as a UE 280 that the Wi-Fi radio is on, with static capabilities, e.g., frequency support, security context, etc. . . . reporting as well that the RRC connection setup is complete. These may be also reported to the CN element 220 with one or more NAS messages. Later, the Wi-Fi 250 reports the dynamic capabilities of the Wi-Fi AP 250, e.g., charging, load to either the eNB 230, through one or more RRC messages, and/or the CN element 220, through one or more NAS messages. The CN element may be, for example, an MME.

FIG. 9 shows an example of dynamic capability signaling for a charging use case, according to embodiments herein, wherein the radio node 250 is the Wi-Fi AP 250, and the radio network node 230 is the eNB 230. FIG. 8 shows the scenario where the network node 210 is the core network node 220, depicted as CN element 220. Here, the indication comprises dynamic capabilities. The UE 280 and the WiFi AP 250 maintain LTE CP connectivity with the eNB 230 and the CN element 220. The UE 280 sends a Wi-Fi proximity indication report with, for example, a Wi-Fi ID, to the CN element 220. The CN element 220 may inquire about the dynamic capability of the WiFi AP 250 with regards, for example, to payment methods for charges incurred. The WiFi AP 250 may then respond to this inquiry by sending the dynamic capability, in e.g., a report, about, for example, the charging to the CN element 220. Based on the received indication, the CN element 220 may make a decision to offload the UE 280 to the WiFi AP 250. The CN element 220 may then send a UE security context message to the WiFi AP 250, and a Wi-Fi security context message to the UE 280. After this, Wi-Fi connectivity may be established between the UE 280 and the WiFi AP 250. The UE 280 may be offloaded to the Wi-Fi AP 250 until the Wi-Fi session ends. Then the WiFi AP 250 may send a new indication comprising the session duration and the charging to the CN element 220. Any of the communications between the UE 280 or the WiFi AP 250 and the CN element 220 take place through the eNB 230 in this example. This is represented in the Figure with the solid circles over the arrows.

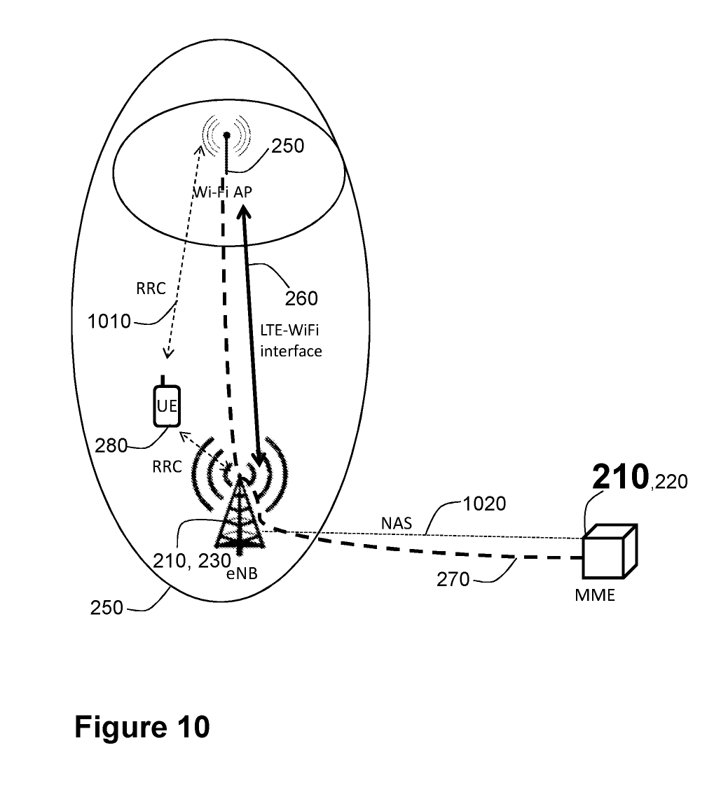

Some advantages of embodiments herein are that the hosting radio network node 230 may now have now a direct communication link to the radio nodes 250, e.g., Wi-Fi APs, within its coverage area. This is depicted in an example in FIG. 10, which illustrates an example scenario of the network elements and links in an LTE-Wi-Fi network setting. The radio network node 230, as network node 210, may now exchange control information about, e.g., offloading, directly with the Wi-Fi AP 250 through the direct control link 270. Also, the radio network node 230 may now have immediate information of all W-Fi APs within its coverage area, e.g., enabling a neighboring W-Fis list to be kept in the radio network node 230. Involvement of the core network node 220 may still be needed to reroute the traffic on the core network side, through the Wi-Fi AP 250. Furthermore, the radio network node 230 may be a transparent element providing the Wi-Fi AP 250 a possibility to exchange information with the MME 220 or any other core network element through e.g., the direct control link 270. Examples of legacy NAS 1020 and RRC 1010 signalling are shown in the Figure.

Another advantage of embodiments herein is that it may be simple to add for example, a 3GPP UE to any existing Wi-Fi AP, even with a fixed backhaul, since many APs are provided to consumers and enterprises as part of an existing cable, fiber, or other fixed or wireless communication subscription. The UE part may be added as a USB-dongle, or by other means even to already deployed APs thus giving the operator access to control a large number of APs that previously were not under its control.

Operators may benefit from embodiments herein in efficient control of radio nodes 250, such as Wi-Fi APs 250, for example, for offloading, healing, and easy tracking of charges. With respect to the existing solutions, a Wi-Fi controlling node(s) and/or an intermediate node(s) that functions between the Wi-Fi controlling node and an LTE core network node may not be needed in the network, which may make the interworking much more simple than today. Furthermore, by knowing the locations of the radio nodes 250, the radio network node 230 may guide the radio node 250 to choose a less congested carrier frequency.

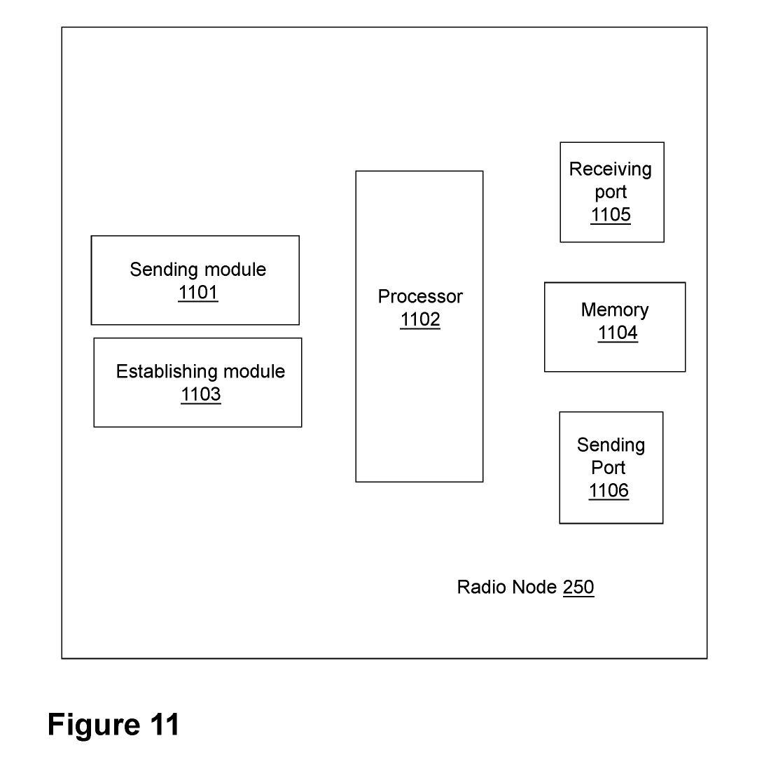

To perform the method actions described above in relation to FIGS. 3-6 and 8-9, the radio node 250 is configured to establish the direct control link 270 with the network node 210. The radio node 250 comprises the following arrangement depicted in FIG. 11. As already mentioned, the network node 210 is configured to operate in the cellular communications system 200. The radio node 250 is configured to operate as a user equipment 280 in the cellular communications system 200.

The detailed description of some of the following corresponds to the same references provided above, in relation to the actions described for the radio node 250, and will thus not be repeated here.

For example, the radio node may be the W-Fi Access Point 250, and the cellular communications system 200 may be the 3GPP network.

The radio node 250 is further configured to, e.g., by means of a sending module 1101 configured to, send the indication to the network node 210, the indication being one of: the category and the capability, the indication comprising the indication that the radio node 250 is capable of operating in the cellular communications system 200 as the short-range radio gateway 250.

The sending module 1101 may be a processor 1102 of the radio node 250.

The capability may comprise at least one of: the used and/or supported short-range radio technologies, the used and/or supported short range radio carrier frequency, the used and/or supported short range radio bands, the used and/or supported security mechanism, the indication of whether offloaded users from the cellular communications system (200) are accepted, the capability to use a 3GPP link as a wireless backhaul, and the current load of the radio node (250) when the threshold is exceeded for a required time.

In some embodiments, the capability is at least one of: a static capability, and a dynamic capability, as described earlier.

In some embodiments, the indication is one of: the field in the ueCapabilityRAT-Container, and the category different from any one of: Category 0, Category 1, Category 2, Category 3, Category 4, Category 5, Category 6, Category 7, Category 8, Category 9, and Category 10.

To send the indication may be configured to be performed by sending the RRC message. In some of these embodiments, the network node 210 is the eNB 230.

In some embodiments, to send the indication is configured to be performed by sending a Non Access Stratum message. In some of these embodiments, the network node 210 is the core network node 220.

The indication may, in some embodiments, further indicate whether the tethering mode is enabled.

The radio node 250 is further configured to, e.g., by means of an establishing module 1103, establish the direct control link 270 with the network node 210 according to the indication configured to be sent.

The establishing module 1103 may be the processor 1102 of the radio node 250.

In some embodiments, the radio node 250 is further configured to establish the additional user plane radio access bearer between the radio node 250 and the network node 210 to the already established user plane radio access bearer between the radio node 250 and the network node 210. This may also be implemented by means of the establishing module 1103.

The embodiments herein for establishing the direct control link 270 with the network node 210 may be implemented through one or more processors, such as the processor 1102 in the radio node 250 depicted in FIG. 11, together with computer program code for performing the functions and actions of the embodiments herein. The program code mentioned above may also be provided as a computer program product, for instance in the form of a data carrier carrying computer program code for performing the embodiments herein when being loaded into the in the radio node 250. One such carrier may be in the form of a CD ROM disc. It is however feasible with other data carriers such as a memory stick. The computer program code may furthermore be provided as pure program code on a server and downloaded to the radio node 250. As indicated above, the processor 1102 may comprise one or more circuits, which may also be referred to as one or more modules in some embodiments, each configured to perform the actions carried out by the radio node 250, as described above in reference to FIG. 11, e.g., the sending module 1101 and the establishing module 1103. Hence, in some embodiments, the sending module 1101 and the establishing module 1103 described above may be implemented as one or more applications running on one or more processors such as the processor 1102. That is, the methods according to the embodiments described herein for the radio node 250 are respectively implemented by means of a computer program product, comprising instructions, i.e., software code portions, which, when executed on at least one processor, cause the at least one processor to carry out the actions described herein, as performed by the radio node 250. The computer program product may be stored on a computer-readable storage medium. The computer-readable storage medium, having stored thereon the computer program, may comprise instructions which, when executed on at least one processor, cause the at least one processor to carry out the actions described herein, as performed by the radio node 250. In some embodiments, the computer-readable storage medium may be a non-transitory computer-readable storage medium, such as a CD ROM disc, or a memory stick. In other embodiments, the computer program product may be stored on a carrier containing the computer program, wherein the carrier is one of an electronic signal, optical signal, radio signal, or the computer-readable storage medium, as described above.

The radio node 250 may further comprise a memory 1104 comprising one or more memory units. The memory 1104 may be arranged to be used to store obtained information, such as the information received by the processor 1102, store data configurations, schedulings, and applications etc. to perform the methods herein when being executed in the radio node 250. Memory 1104 may be in communication with the processor 1102. Any of the other information processed by the processor 1102 may also be stored in the memory 1104.

In some embodiments, information e.g., from the network node 210, may be received through a receiving port 1105. The receiving port 1105 may be in communication with the processor 1102. The receiving port 1105 may also be configured to receive other information.

The processor 1102 may be further configured to send messages, e.g., to the network node 210, through a sending port 1106, which may be in communication with the processor 1102, and the memory 1104.

Those skilled in the art will also appreciate that the any module within the radio node 250, e.g., the sending module 1101 and the establishing module 1103 described above, may refer to a combination of analog and digital circuits, and/or one or more processors configured with software and/or firmware, e.g. stored in the memory, that when executed by the one or more processors such as the processor 1102, perform actions as described above, in relation to FIGS. 3-6 and 8-9. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

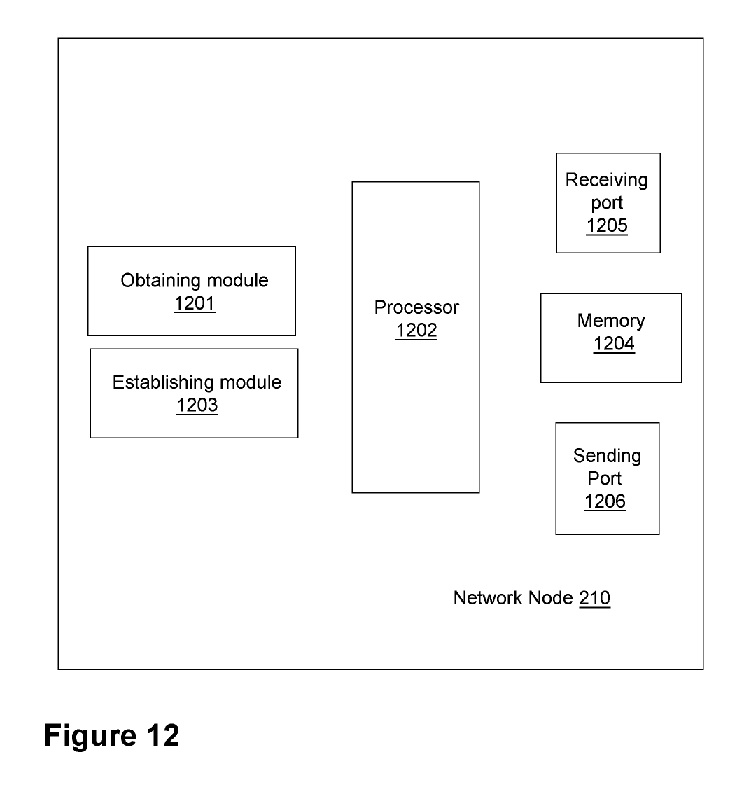

To perform the method actions described above in relation to FIGS. 3, and 5-9, the network node 210 is configured to establish the direct control link 270 with the radio node 250. The network node 210 comprises the following arrangement depicted in FIG. 12. As already mentioned, the network node 210 is configured to operate in the cellular communications system 200. The network node 210 is configured to operate as the user equipment 280 in the cellular communications system 200.

The detailed description of some of the following corresponds to the same references provided above, in relation to the actions described for the network node 210, and will thus not be repeated here.

For example, the radio node may be the W-Fi Access Point 250, and the cellular communications system 200 may be the 3GPP network.

The network node 210 is further configured to, e.g., by means of an obtaining module 1201 configured to, obtain the indication to the network node 210, the indication being one of: the category and the capability, the indication comprising the indication that the radio node 250 is capable of operating in the cellular communications system 200 as the short-range radio gateway 250.

The obtaining module 1201 may be a processor 1202 of the network node 210.

The capability may comprise at least one of: the used and/or supported short-range radio technologies, the used and/or supported short range radio carrier frequency, the used and/or supported short range radio bands, the used and/or supported security mechanism, the indication of whether offloaded users from the cellular communications system (200) are accepted, the capability to use a 3GPP link as a wireless backhaul, and the current load of the radio node (250) when the threshold is exceeded for a required time.

In some embodiments, the capability is at least one of: a static capability, and a dynamic capability, as described earlier.

In some embodiments, the indication is one of: the field in the ueCapabilityRAT-Container, and the category different from any one of: Category 0, Category 1, Category 2, Category 3, Category 4, Category 5, Category 6, Category 7, Category 8, Category 9, and Category 10.

To obtain the indication may be configured to be performed by receiving the RRC message. In some of these embodiments, the network node 210 is the eNB 230.

In some embodiments, to obtain the indication is configured to be performed by receiving a Non Access Stratum message. In some of these embodiments, the network node 210 is the core network node 220.

The indication may, in some embodiments, further indicate whether the tethering mode is enabled.

The network node 210 is further configured to, e.g., by means of an establishing module 1203, establish the direct control link 270 with the radio node 250 according to the indication configured to be obtained.

The establishing module 1203 may be the processor 1202 of the network node 210.

In some embodiments, the network node 210 is further configured to establish the additional user plane radio access bearer between the radio node 250 and the network node 210 to the already established user plane radio access bearer between the radio node 250 and the network node 210. This may also be implemented by means of the establishing module 1103.

The embodiments herein for establishing the direct control link 270 with the radio node 250 may be implemented through one or more processors, such as the processor 1202 in the network node 210 depicted in FIG. 12, together with computer program code for performing the functions and actions of the embodiments herein. The program code mentioned above may also be provided as a computer program product, for instance in the form of a data carrier carrying computer program code for performing the embodiments herein when being loaded into the in the network node 210. One such carrier may be in the form of a CD ROM disc. It is however feasible with other data carriers such as a memory stick. The computer program code may furthermore be provided as pure program code on a server and downloaded to the network node 210. As indicated above, the processor 1202 may comprise one or more circuits, which may also be referred to as one or more modules in some embodiments, each configured to perform the actions carried out by the network node 210, as described above in reference to FIG. 12, e.g., the obtaining module 1201 and the establishing module 1203. Hence, in some embodiments, the obtaining module 1201 and the establishing module 1203 described above may be implemented as one or more applications running on one or more processors such as the processor 1202. That is, the methods according to the embodiments described herein for the network node 210 are respectively implemented by means of a computer program product, comprising instructions, i.e., software code portions, which, when executed on at least one processor, cause the at least one processor to carry out the actions described herein, as performed by the network node 210. The computer program product may be stored on a computer-readable storage medium. The computer-readable storage medium, having stored thereon the computer program, may comprise instructions which, when executed on at least one processor, cause the at least one processor to carry out the actions described herein, as performed by the network node 210. In some embodiments, the computer-readable storage medium may be a non-transitory computer-readable storage medium, such as a CD ROM disc, or a memory stick. In other embodiments, the computer program product may be stored on a carrier containing the computer program, wherein the carrier is one of an electronic signal, optical signal, radio signal, or the computer-readable storage medium, as described above.

The network node 210 may further comprise a memory 1204 comprising one or more memory units. The memory 1204 may be arranged to be used to store obtained information, such as the information received by the processor 1202, store data configurations, schedulings, and applications etc. to perform the methods herein when being executed in the network node 210. Memory 1204 may be in communication with the processor 1202. Any of the other information processed by the processor 1202 may also be stored in the memory 1204.

In some embodiments, information e.g., from the radio node 250, may be received through a receiving port 1205. The receiving port 1205 may be in communication with the processor 1202. The receiving port 1205 may also be configured to receive other information.

The processor 1202 may be further configured to send messages, e.g., to the radio node 250, through a sending port 1206, which may be in communication with the processor 1202, and the memory 1204.

Those skilled in the art will also appreciate that the any module within the network node 210, e.g., the obtaining module 1201 and the establishing module 1203 described above, may refer to a combination of analog and digital circuits, and/or one or more processors configured with software and/or firmware, e.g. stored in the memory, that when executed by the one or more processors such as the processor 1202, perform actions as described above, in relation to FIGS. 3, and 5-9. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

1. A method performed by a radio node for establishing a direct control link with a network node, the network node operating in a cellular communications system, and the radio node operating as a user equipment in the cellular communications system, the method comprising:
sending an indication to the network node, the indication being one of: a category and a capability, the indication comprising an indication that the radio node is capable of operating in the cellular communications system as a short-range radio gateway, and
establishing the direct control link with the network node according to the sent indication.

2. The method of claim 1, wherein the capability comprises at least one of: used and/or supported short-range radio technologies, used and/or supported short range radio carrier frequency, used and/or supported short range radio bands, used and/or supported security mechanism, an indication of whether offloaded users from the cellular communications system are accepted, a capability to use a 3GPP link as a wireless backhaul, and a current load of the radio node when a threshold is exceeded for a required time.

3. The method of claim 2, wherein the capability is at least one of: a static capability, and a dynamic capability.

4. The method of claim 1, wherein the indication is one of: a field in the ueCapabilityRAT-Container, and a category different from any one of: Category 0, Category 1, Category 2, Category 3, Category 4, Category 5, Category 6, Category 7, Category 8, Category 9, and Category 10.

5. The method of claim 1, wherein the sending the indication is performed by sending a Radio Resource Control message, and wherein the network node is an eNB.

6. The method of claim 1, wherein the sending the indication is performed by sending a Non Access Stratum message and wherein the network node is a core network node.

7. The method of claim 1, further comprising:
establishing an additional user plane radio access bearer between the radio node and the network node to an already established user plane radio access bearer between the radio node and the network node.

8. (canceled)

9. A method performed by a network node for establishing a direct control link with a radio node, the network node operating in a cellular communications system, and the radio node operating as a user equipment in the cellular communications system, the method comprising:
obtaining an indication from the radio node, the indication being one of: a category and a capability, the indication comprising an indication that the radio node is capable of operating in the cellular communications system as a short-range radio gateway, and
establishing the direct control link with the radio node according to the obtained indication.

10. The method of claim 9, wherein the capability comprises at least one of: used and/or supported short-range radio technologies, used and/or supported short range radio carrier frequency, used and/or supported short range radio bands, used and/or supported security mechanism, an indication of whether offloaded users from the cellular communications system are accepted, a capability to use a 3GPP link as a wireless backhaul, and a current load of the radio node when a threshold is exceeded for a required time.

11. The method of claim 10, wherein the capability is at least one of: a static capability, and a dynamic capability.

12. The method of claim 9, wherein the indication is one of: a field in the ueCapabilityRAT-Container, and a category different from any one of: Category 0, Category 1, Category 2, Category 3, Category 4, Category 5, Category 6, Category 7, Category 8, Category 9, and Category 10.

13. The method of claim 9, wherein the obtaining the indication is performed by receiving a Radio Resource Control message, and wherein the network node is an eNB.

14. The method of claim 9 wherein the obtaining is performed by receiving a Non Access Stratum message, and wherein the network node is a core network node.

15. The method of claim 9, further comprising:
establishing an additional user plane radio access bearer between the radio node and the network node to an already established user plane radio access bearer between the radio node and the network node.

16. (canceled)

17. A radio node configured to establish a direct control link with a network node, the network node being configured to operate in a cellular communications system, and the radio node being configured to operate as a user equipment in the cellular communications system, the radio node being further configured to:
send an indication to the network node, the indication being one of: a category and a capability, the indication comprising an indication that the radio node is capable of operating in the cellular communications system as a short-range radio gateway, and
establish the direct control link with the network node according to the indication configured to be sent.

18. The radio node of claim 17, wherein the capability comprises at least one of: used and/or supported short-range radio technologies, used and/or supported short range radio carrier frequency, used and/or supported short range radio bands, used and/or supported security mechanism, an indication of whether offloaded users from the cellular communications system are accepted, a capability to use a 3GPP link as a wireless backhaul, and a current load of the radio node when a threshold is exceeded for a required time.

19. The radio node of claim 18, wherein the capability is at least one of: a static capability, and a dynamic capability.

20. The radio node of claim 17, wherein the indication is one of: a field in the ueCapabilityRAT-Container, and a category different from any one of: Category 0, Category 1, Category 2, Category 3, Category 4, Category 5, Category 6, Category 7, Category 8, Category 9, and Category 10.

21. The radio node of claim 17, wherein to send the indication is configured to be performed by sending a Radio Resource Control message, and wherein the network node is an eNB.

22. The radio node of claim 17, wherein to send the indication is configured to be performed by sending a Non Access Stratum message, and wherein the network node is a core network node.

23. The radio node of claim 17, wherein the radio node is further configured to:
establish an additional user plane radio access bearer between the radio node and the network node to an already established user plane radio access bearer between the radio node and the network node.

24. A network node configured to establish a direct control link with a radio node, the network node being configured to operate in a cellular communications system, and the radio node being configured to operate as a user equipment in the cellular communications system, the network node being further configured to:
obtain an indication from the radio node, the indication being one of: a category and a capability, the indication comprising an indication that the radio node is capable of operating in the cellular communications system as a short-range radio gateway, and
establish the direct control link with the radio node according to the indication configured to be obtained.

25. The network node of claim 24, wherein the capability comprises at least one of: used and/or supported short-range radio technologies, used and/or supported short range radio carrier frequency, used and/or supported short range radio bands, used and/or supported security mechanism, an indication of whether offloaded users from the cellular communications system are accepted, a capability to use a 3GPP link as a wireless backhaul, and a current load of the radio node when a threshold is exceeded for a required time.

26. The network node of claim 25, wherein the capability is at least one of: a static capability, and a dynamic capability.

27. The network node of claim 24, wherein the indication is one of: a field in the ueCapabilityRAT-Container, and a category different from any one of: Category 0, Category 1, Category 2, Category 3, Category 4, Category 5, Category 6, Category 7, Category 8, Category 9, and Category 10.

28. The network node of claim 24, wherein to obtain the indication is configured to be performed by receiving a Radio Resource Control message, and wherein the network node is an eNB.

29. The network node of claim 24, wherein to obtain is configured to be performed by receiving a Non Access Stratum message, and wherein the network node is a core network node.

30. The network node of claim 24, wherein the network node is further configured to:
establish an additional user plane radio access bearer between the radio node and the network node to an already established user plane radio access bearer between the radio node and the network node.
